(19) United States
(12) Patent Application Publication
(10) Pub. No.: US 2023/0322183 A1
(43) Pub. Date: Oct. 12, 2023

(54) THEFT-DETERRENT SYSTEMS AND METHODS USING ONBOARD WEIGHT SENSORS

(71) Applicant: Ford Global Technologies, LLC, Dearborn, MI (US)

(72) Inventor: Aed M. Dudar, Canton, MI (US)

(73) Assignee: Ford Global Technologies, LLC, Dearborn, MI (US)

(21) Appl. No.: 17/658,954

(22) Filed: Apr. 12, 2022

(51) Int. Cl. B60R 25/01; G01G 19/08; B60R 25/30; B60R 25/102; B60R 25/31; B60R 25/34

(52) U.S. Cl. CPC B60R 25/01; G01G 19/08; B60R 25/305; B60R 25/102; B60R 25/31; B60R 25/34

(57) ABSTRACT

Theft deterrent systems and methods using onboard weight sensors are disclosed herein. An example method can include determining a key-off event of a vehicle, determining a baseline weight value from a scale placed in a location on a vehicle, determining a weight change relative to the baseline weight value that indicates that an object has been removed or added to the location, waking up a control module of the vehicle based on the weight change and activating a camera to obtain an image of an area around the location.

### BACKGROUND

Some vehicles, such as pickup trucks have introduced onboard scales. The scales can measure the weight of the cargo. Users can weigh cargo and/or trailer weight to ensure that any applicable weight limit is not exceeded. Vehicle owners may place various expensive items such as tools and hobby equipment in the bed of the truck. However, these items may be stolen if left in the bed of the truck. To prevent such theft, some owners may chain the equipment to the truck which requires additional labor, buying a chain, locking it, or other similar scenarios. One example of addressing theft issues involves placing Radio Frequency (RF) tag system for items stored in the bed to prevent loss/theft. Placing an RF tag on each tool takes time and the owner may forego this step. RF tags may be defeated by various methods as well.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example environment where aspects of the present disclosure may be practiced.

FIG. 2 is a schematic diagram of an example Hot At All Times (HAAT) circuit of the present disclosure.

FIG. 3 illustrates an example architecture where a body control module can be coupled with a circuit that can include both a gain HAAT circuit and a loss HAAT circuit.

FIG. 4 illustrates a graphical user interface displayed on a mobile device.

FIG. 5 is a flowchart of an example method of the present disclosure.

### DETAILED DESCRIPTION

### Overview

Theft-deterrent systems and methods using onboard weight sensing are disclosed herein. In one use case, an onboard scale can measure a load in a bed of a truck. The bed could be empty or can have personal belongings in the form of tools, scooters, bikes, and other equipment. Many onboard modules are capable of being awakened. For example, a powertrain control module (PCM) can be awakened on a door ajar event to prime a fuel rail in anticipation of an engine start. In another example, a body control module (BCM) may be awakened by a key fob to unlock a vehicle door. These are merely examples of vehicle components that can be used to awaken or prime a vehicle system. Likewise, the present disclosure can utilize an onboard scale incorporated into the vehicle to awaken an onboard camera when a weight difference event is detected (e.g., either weight loss or weight gain).

A module wake mechanism can be used to wake up one or more vehicle camera(s) when a weight-loss event is detected, for example, in the bed of the truck. When an item is removed from the truck bed, it may be detected by an onboard scale as a weight-loss event. In some instances, a Hot At All Times (HAAT) circuit can be used to input onboard scale values at key-off. The onboard scale values are a voltage measurement that is proportional to a weight in the vehicle at key-off. The BCM can be configured to read the payload at key-off and provide the same to a comparator circuit as a digital-to-analog signal which is latched by a chip before the BCM module enters a sleep mode. A comparator Op-Amp circuit can be used utilized to wake up an onboard camera along with the BCM when the weight in the truck bed changes by an amount. The wake signal may be armed by the truck owner via a human-machine interface (HMI) or other control/application as the owner may not want the feature to be active at all times. Op-amps contain an enable personal identification number (PIC) which may be controlled by the BCM.

If the owner arms the wake circuit, then any weight loss in the truck cargo after key-off as measured by the onboard scale may wake up a selected vehicle module to cause one or more onboard cameras (e.g., front, side, rear, and cargo) to obtain repeated images of the surrounding to capture and image of the event (and possibly the individual). Photos can be transmitted to the vehicle owner wirelessly to an application on a smart device through a service provider. The owner can review the photos to determine if the activity is theft and if so, may turn on the vehicle's horn/lights using the application to deter the theft.

Images can be stored by the service provider for further analysis and recognition. If vehicle-to-vehicle (V2V) technology is enabled on the truck, nearby vehicles may be awakened by a wireless signal from the truck with the wake circuit. Peer vehicles can be requested to use their cameras to take images of the surroundings. This maximizes the coverage of the imaging in an effort to identify the intrusion. While the cameras may be used, it will be understood that in areas where there is a lot of human activity, they may produce too many false positives. The onboard scale is a better indicator than an item in the bed of the truck has been removed. Cameras images are only snapped only when a payload change is detected.

It will be understood that these methods add a layer of protection for items left in the cargo bed and deter theft. In some instances, the systems and methods can be monitored for delivery packages being placed into the cargo bed.

### Illustrative Embodiments

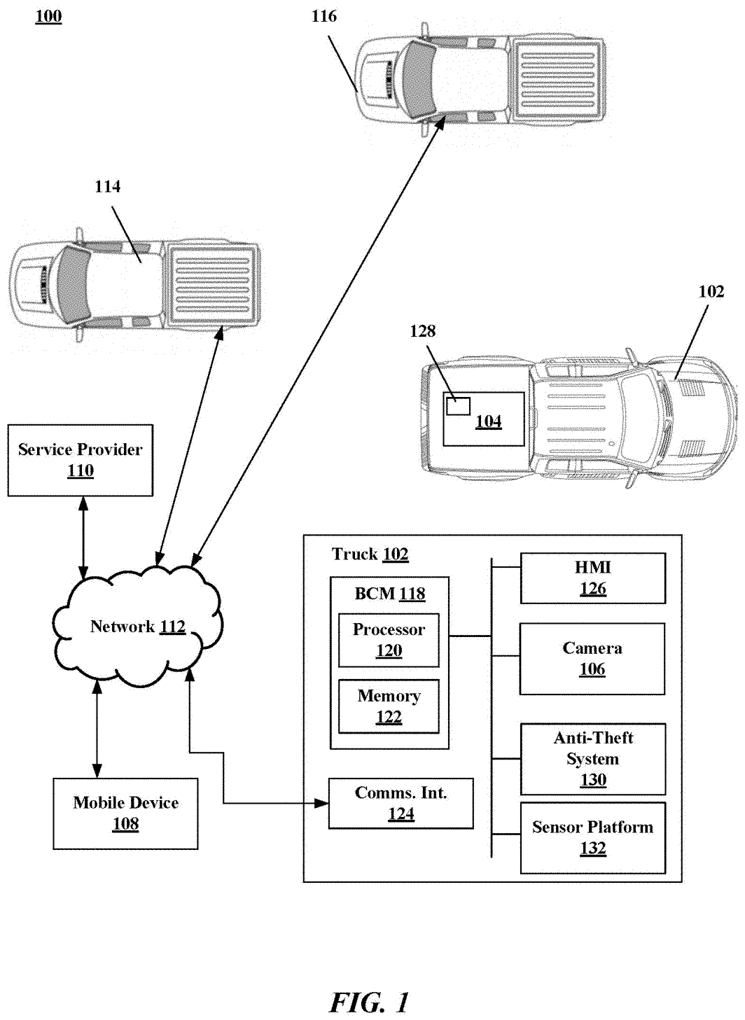

Turning now to the drawings, FIG. 1 depicts an illustrative architecture 100 in which techniques and structures of the present disclosure may be implemented. The architecture 100 includes a truck 102, a scale 104, a camera 106, a mobile device 108, a service provider 110, and a network 112. The network 112 can include combinations of networks. For example, the network 112 may include any one or a combination of multiple different types of networks, such as cellular, cable, the Internet, wireless networks, and other private and/or public networks. The network 112 can include either or both short and long-range wireless networks.

In some instances, the architecture 100 can comprise additional vehicles 114 and 116 that are located within a certain proximity to the truck 102. For example, the truck 102 (and the additional vehicles) may be enabled with vehicle-to-vehicle (V2V) communication capabilities. The V2V communications can be short and/or long-range wireless communications.

It will be understood that while descriptions herein may reference the use of a scale in a bed of the truck 102 as an example, weight scales can be incorporated into any type of vehicle. For example, a scale may be incorporated into a trunk of a car. A scale may also be incorporated into a dedicated package location in a delivery vehicle. Thus, the descriptions involving a truck are non-limiting and merely for explanatory purposes.

The truck 102 can comprise a BCM 118 that comprises a processor 120 and memory 122. The processor 120 executes instructions stored in memory 122 to perform any of the methods disclosed herein. When referring to actions performed by the BCM 118, it will be understood that this includes execution of instructions by the processor 120. The truck 102 can also comprise a communications interface 124 that allows the BCM 118 to access the network 112. In some instances, the truck 102 also comprises a human-machine interface 126 that allows a user to view camera images obtained from the camera 106.

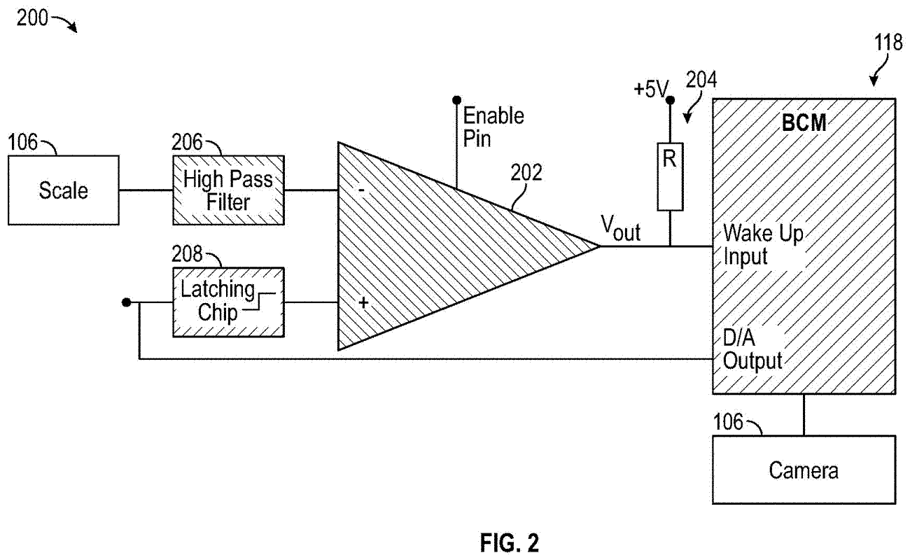

Referring now to FIGS. 1 and 2, the BCM 118 may be part of a HAAT circuit 200 (e.g., weight change comparator circuit) that is used to wake up the BCM 118 and camera 106 when weight loss is detected by the scale 104. The HAAT circuit 200 comprises an op-amp 202, and pull-up resistor 204, a high-pass filter 206, a latching chip 208, and enable pin 210. In some configurations, one leg of pull-up resistor 240 is coupled to a voltage source (5V). The other leg (Vout) can be either zero or 5V depending on op-amp 202 inputs. If the op-amp 202 output is zero, then the input read is zero signal. If the op-amp 202 output is 5V, then input read is high. The pullup resistor prevents a short circuit between 5V and zero volts.

In general, the scale 104 is electrically coupled to the high-pass filter 206 that is in turn electrically coupled to a positive terminal of the op-amp 202. The latching chip 208 is coupled to a negative terminal of the op-amp 202.

At key-off the BCM 118 determines a weight value from the scale 104. This value is a baseline or tare value that is used to compare against and detect weight loss/gain events occurring after the key-off event. In some instances, each key-off event resets the circuit. This baseline value can be fed into the op-amp 202 through the latching chip 208. In some instances, the BCM 118 outputs a cargo payload value at key-off, which is equal to the measured weight.

In general, the operational amplifier 202 is coupled with the scale 104. The operational amplifier 202 can be configured to input a scale value (e.g., baseline value) at a key-off event and compare a baseline weight value to a current weight to determine a weight change. As noted herein, the baseline weight value can be transmitted as a digital to an analog signal that is latched by the latching chip 208 before the BCM 118 enters a low power or sleep mode.

After the key-off event and the baseline scale value is obtained, the op-amp 202 can then monitor for changes in weight as measured by the scale 104. As noted above, the BCM 118 can be electrically coupled to an output of the op-amp 202 and provides wake-up input to the BCM 118. For example, when the op-amp 202 outputs zero voltage the BCM 118 remains asleep (e.g., Vout=0). However, when the op-amp 202 outputs voltage the BCM 118 wakes up (e.g., Vout>0).

The output of the scale 104 is monitored after the key-off event. When the BCM 118 detects that the Vout of the op-amp 202 is not zero, the BCM 118 can activate the camera 106 (see FIG. 1), as will be discussed in greater detail herein.

The HAAT circuit 200 can also be configured to detect weight gain by the scale 104. For example, when someone places an object in the bed of the truck 102 after a key-off event, the BCM 118 can be configured to detect additional weight added to the bed by the object. When the BCM 118 detects that the Vout of the op-amp 202 is not zero, the BCM 118 can activate the camera 106 (see FIG. 1). Thus, detected changes in the Vout of the op-amp 202 can be correlated to either weight gain or loss, which results in activation of the camera 106 and/or other remediations or responses.

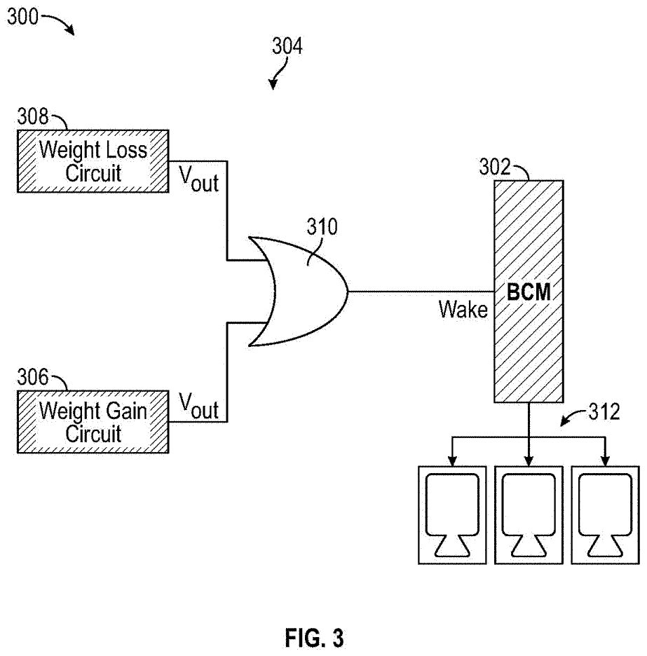

FIG. 3 is an example architecture 300 where a BCM 302 (see BCM 118 of FIG. 1) can be coupled with a circuit 304 that can include both a gain HAAT circuit 306 and a loss HAAT circuit 308. In this configuration, the gain HAAT circuit 306 and the loss HAAT circuit 308 can be electrically coupled to the BCM 302 through an OR gate 310. In general, the OR gate 310 acts as a switch to transmit signals to the BCM 302 based on whether signals are received from the gain HAAT circuit 306 or the loss HAAT circuit 308.

When a signal is received that indicates that a weight change has occurred, the BCM 302 can activate cameras 312. In general, the cameras 312 can include a single camera that is directed towards the bed of the truck. Other cameras can be activated too such as side view, mirror, front/rear, tailgate, puddle, and/or other cameras that may be present. In some instances, the BCM 302 can activate other vehicle components such as proximity sensors to detect when an object, such as a person, is close to the truck when the weight change is detected. The BCM 302 can detect the presence of an object and selectively activate a camera that has a field of view in the direction of the object.

In sum, the architecture 300 can determine that the object has been added when the weight change is indicative of an increase in weight and that the object has been removed when the weight change is indicative of a decrease in weight. Thus, regardless of the change in weight (positive or negative), the driver (or another user) of the truck 102 can be alerted.

Referring collectively to FIGS. 1 and 2, in an example use case, at a key-off event, the BCM 118 can obtain a baseline weight value from the scale 104. In one example, the BCM 118 receives the baseline weight value from the scale 104 through the positive connection of the op-amp 202. This includes the weight of an object 128. For example, the BCM 118 can receive a signal from the truck's ignition module. In some instances, the driver can arm the weight analysis feature using the vehicle HMI 126 or through a mobile application executing on their mobile device 108. The BCM 118 can feed this value back to the op-amp 202 through the latching chip 208 and the negative terminal of the op-amp 202. After the key-off event and baseline weight have been obtained. In this example, an individual removes an item or object from the bed of the truck 102 and this weight change is detected by the scale 104. The BCM 118 can be awakened when the scale 104 outputs a signal to the op-amp 202 that indicates this weight change.

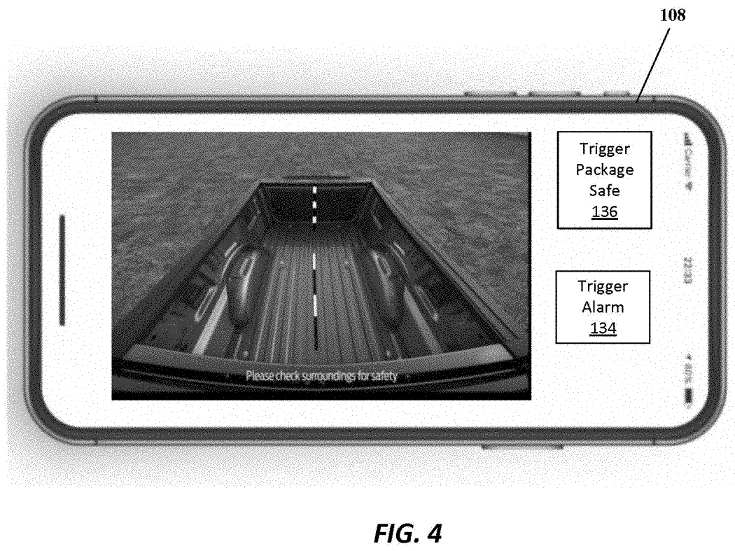

Upon wakeup, the BCM 118 activates the camera 106. In this example, the camera 106 can obtain images of the bed of the truck and of all the contents therein. These images can be transmitted over the network 112 to the service provider 110. Referring now to FIG. 4, the images can be forwarded to the mobile device 108 to allow the user to identify if an item is missing. The user can trigger an anti-theft system 130 (FIG. 1) of the truck through a button 134 or other similar object on the mobile device 108. Another button 136 can be provided that allows a user to arm the package safety system.

In reference to FIG. 1, the mobile device 108 can execute an application that allows a user to interact with the service provider 110 and/or the BCM 118 through a message transmitted over the network 112. As noted above, the anti-theft system 130 can also be triggered using signals obtained from a sensor platform 132 of the truck 102. The sensor platform 132 can include sensors such as LiDAR, ultrasonic, infrared (IR), or any other proximity or object detecting sensors that would be known to one of skill in the art.

Referring back to FIG. 1, in addition to activating the anti-theft system 130 of the truck 102, the BCM 118 can transmit V2V messages to surrounding vehicles 114 and 116 to activate their cameras to obtain images of the area around the truck 102, or of the area in the vicinity of the truck 102. Thus, once the BCM 118 awakes and activates the camera 106, or takes other remediating measures, such as activating the anti-theft system 130, the BCM 118 can transmit messages to the surrounding vehicles 114 and 116. In some instances, the surrounding vehicles 114 and 116 can transmit their images to the mobile device 108 or additionally, to the service provider 110. The service provider 110 can store images from the truck 102 and/or the surrounding vehicles 114 and 116 in a data store. These images can also be transmitted to the mobile device 108.

Also, the same processes disclosed herein for determining the removal of items from a vehicle using a scale can be replicated when items are placed into the vehicle. In some instances, when the BCM 118 awakes after an item has been added to the bed of the truck 102 after key-off event, the BCM 118 can activate the camera 106 and transmit images to the mobile device 108. The user of the mobile device 108 can use the images to verify that the item placed in the vehicle is present. Also, in some instances, the BCM 118 can reset the baseline weight value so that it takes into account the item. Thus, removal of the item can be sensed and alerted in accordance with the methods disclosed above.

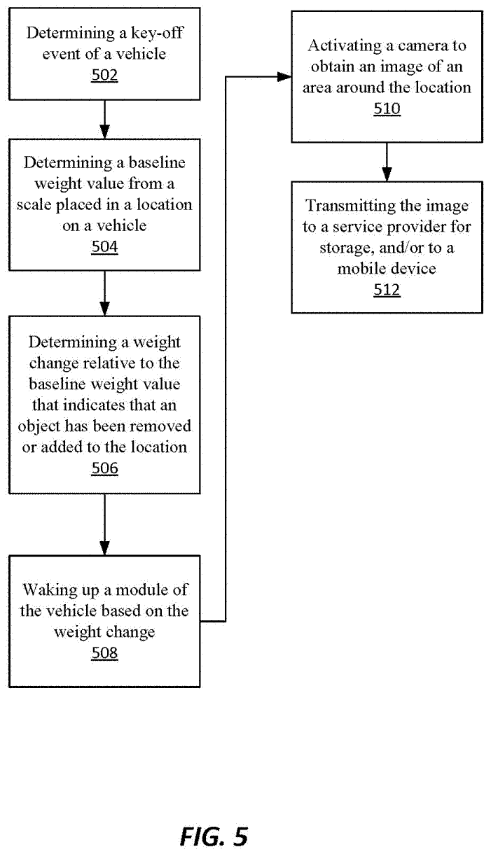

FIG. 5 is a flowchart of an example method of the present disclosure. The method can include a step 502 of determining a key-off event of a vehicle. For example, a BCM can detect that the vehicle has been turned off by a driver. These signals can be received from an ignition module of the vehicle, for example. Next, the method can include a step 504 of determining a baseline weight value from a scale placed in a location on a vehicle. The baseline weight can include the weight of any items placed on the scale. The baseline weight is received from the scale as provided through a HAAT circuit as described above.

The method can also include a step 506 of determining a weight change relative to the baseline weight value that indicates that an object has been removed or added to the location. For example, when an object is removed off the scale, the HAAT circuit can function as a comparator that compares a current scale value to the baseline weight value. When a discrepancy exists, a signal output by the HAAT circuit can awaken the BCM.

Thus, the method includes a step 508 of waking up a module of the vehicle based on the weight change. As noted above, the BCM can determine that an object has been added when the weight change is indicative of an increase in weight and that an object has been removed when the weight change is indicative of a decrease in weight.

The method can include a step 510 of activating a camera to obtain an image of an area around the location. In addition to obtaining images, the method can include automatically triggering an anti-theft system of the vehicle to sound an alarm, honk a horn, and/or activate lights of the vehicle. In some instances, the method can include a step 512 of transmitting the image to a service provider for storage, and/or to a mobile device.

Implementations of the systems, apparatuses, devices and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims may not necessarily be limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “mechanically connected,” etc., are used interchangeably herein to generally refer to the condition of being mechanically/physically connected. The terms “couple” and “coupling” are also used in a non-mechanical/physical context that refers to absorption of microwave energy by a material. It is further noted that various figures (including component diagrams) shown and discussed herein are for illustrative purpose only, and are not drawn to scale. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three-dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method comprising:
determining a key-off event of a vehicle;
determining a baseline weight value from a scale placed in a location on a vehicle;
determining a weight change relative to the baseline weight value that indicates that an object has been removed or added to the location; and
activating a camera to obtain an image of an area around the location.

2. The method according to claim 1, further comprising transmitting the image to a service provider for storage.

3. The method according to claim 1, further comprising transmitting the image to a mobile device.

4. The method according to claim 3, further comprising:
receiving a response from the mobile device; and
activating an anti-theft system of the vehicle based on the response.

5. The method according to claim 1, further comprising transmitting a message to another vehicle using a vehicle-to-vehicle protocol to request the another vehicle to obtain images of an area around the vehicle, the another vehicle transmitting the images to a service provider or a mobile device of a user of the vehicle.

6. The method according to claim 1, further comprising detecting presence of an individual in proximity to the vehicle using a sensor of a sensor platform.

7. The method according to claim 6, further comprising activating another camera pointed in a direction of the individual.

8. The method according to claim 1, further comprising determining that the object has been added when the weight change is indicative of an increase in weight and that the object has been removed when the weight change is indicative of a decrease in weight.

9. A system comprising:
a camera;
a scale;
a circuit that comprises an operational amplifier coupled with the scale, the operational amplifier being configured to input a scale value at a key-off event and compare a baseline weight value to a current weight to determine a weight change; and
a control module comprising a processor and memory, the processor executing instructions stored in memory to:
determine the key-off event;
determine the current weight from the scale; and
activate the camera to obtain an image of an area around a location of the scale after being awakened by the circuit and receiving a signal from the circuit that is indicative of the weight change.

10. The system according to claim 9, further comprising a high-pass filter placed between the scale and the operational amplifier.

11. The system according to claim 9, further comprising a latching chip electrically coupling the control module to the operational amplifier.

12. The system according to claim 9, wherein the control module is awakened when the operational amplifier outputs a non-zero value.

13. The system according to claim 9, wherein the control module is configured to transmit the image to a service provider for storage and/or to a mobile device.

14. The system according to claim 13, wherein the control module is configured to:
receive a response from the mobile device; and
activate an anti-theft system of a vehicle based on the response.

15. The system according to claim 9, wherein the control module is configured to transmit a message to another vehicle using a vehicle-to-vehicle protocol to request the another vehicle to obtain images of an area around a vehicle, the another vehicle transmitting the images to a service provider or a mobile device of a user of the vehicle.

16. The system according to claim 9, wherein the control module is configured to detect presence of an individual in proximity to a vehicle using a sensor of a sensor platform; and activate another camera pointed in a direction of the individual.

17. A control module comprising:
a processor and memory, the processor executing instructions stored in memory to:
determine a key-off event for a vehicle;
determine a baseline weight value from a scale of the vehicle;
wake up upon receiving a signal from a circuit coupled with the scale of a vehicle, the signal indicating a weight change relative to the baseline weight value; and
activate a camera to obtain an image of an area around a location of the scale after being awakened by the circuit and receiving the signal from the circuit that is indicative of the weight change.

18. The control module according to claim 17, wherein the processor is configured to determine that an object has been added when the weight change is indicative of an increase in weight and that the object has been removed when the weight change is indicative of a decrease in weight.

19. The control module according to claim 18, wherein the processor is configured to transmit the image to a service provider for storage, or to a mobile device.

20. The control module according to claim 19, wherein the processor is configured to:
receiving a response from the mobile device; and
activating an anti-theft system of the vehicle based on the response.
